(19) United States
(12) Patent Application Publication
(10) Pub. No.: US 2009/0145977 A1
(43) Pub. Date: Jun. 11, 2009

(54) INJECTION MOLDED NOZZLE AND INJECTOR COMPRISING THE INJECTION MOLDED NOZZLE

(76) Inventors: Jan Ihle, Deutschlandsberg (AT); Werner Kahr, Deutschlandsberg (AT)

Correspondence Address: FISH & RICHARDSON PC, P.O. BOX 1022, MINNEAPOLIS, MN, 55440-1022, US

(21) Appl. No.: 11/950,666

(22) Filed: Dec. 5, 2007

(51) Int. Cl. B05B 1/24

(52) U.S. Cl. 239/136; 239/132

(57) ABSTRACT

An injection molded nozzle includes a base body having a fluid channel, a fluid inlet, and a fluid outlet. The base body is made of a ceramic material with a positive temperature coefficient. The base body, in response to an electrical current, is configured to vaporize a fluid receivable in the fluid channel by heating. The fluid outlet is configured to eject vaporized fluid as a spray.

### CROSS-REFERENCE TO RELATED APPLICATIONS

The following patent applications, all of which were filed on the same day as this patent application, are hereby incorporated by reference into this patent application as if set forth herein in full: (1) U.S. patent application Ser. No. ______, entitled “Injection Molded PTC-Ceramics”, Attorney Docket No. 14219-186001, Application Ref. P2007,1179USE; (2) U.S. patent application Ser. No. ______, entitled “Feedstock And Method For Preparing The Feedstock”, Attorney Docket No. 14219-187001, Application Ref. P2007,1180USE; (3) U.S. patent application Ser. No. ______, entitled “Mold Comprising PTC-Ceramic”, Attorney Docket No. 14219-184001, Application Ref. P2007,1181USE; (4) U.S. patent application Ser. No. ______, entitled “Process For Heating A Fluid And An Injection Molded Molding”, Attorney Docket No. 14219-182001, Application Ref. P2007,1182USE; and (5) U.S. patent application Ser. No. ______, entitled “PTC-Resistor”, Attorney Docket No. 14219-185001, Application Ref. P2007,1184USE.

### BACKGROUND

The PTC-effect of ceramic material comprises a change of the specific electric resistivity ρ as a function of the temperature T. While in a certain temperature range the resistivity ρ is small with a rise of the temperature T, starting at the so-called Curie-temperature T_{C}, the resistivity ρ increases with a rise of temperature. In this second temperature range, the temperature coefficient, which is the relative change of the resistivity at a given temperature, can be in a range of 50%/K up to 100%/K.

### SUMMARY

An injection molded nozzle is described, comprising a base body with a fluid channel connected to a fluid inlet and a fluid outlet. The base body comprises a ceramic material with a positive temperature coefficient of its resistance, henceforth termed “PTC ceramic”. Upon application of a current, the base body is heated in a manner vaporizing a fluid receivable in the fluid channel. The fluid outlet is provided with a shape enabling ejection of the fluid as a vapour spray.

The nozzle is suited to directly vaporizing a fluid flowing through it, such as a chemically combustible fuel, so that the fuel can be released, in vaporous form, in or onto another medium. For example, the vaporized fuel may be ejected into a combustion chamber, where it is mixed with air to create a combustible mixture for the purpose of, for example, displacing a cylinder of an internal combustion engine. Fuels vaporizable by the nozzle particularly include ethanol. However, the PTC properties of the nozzle, that is, the constitution of the PTC ceramic, can also be adjusted to vaporize other fuels such as gasoline or diesel.

Since the nozzle itself constitutes a part of a mechanism to vaporize any fluid flowing through it, additional heating or vaporizing mechanism, such as an additional heat exchanger in the form, for example, of wiring, piping or a heating rod need not be placed in contact with the fluid or into the nozzle itself. This greatly simplifies the construction, form and cost of the mechanism to heat the fluid. Furthermore, as the nozzle itself constitutes a heating mechanism for the fluid, its entire surface in contact with the fluid can be used as a heat exchanging mechanism for the purpose of vaporizing the fluid. This facilitates vaporizing the fluid in a particularly short amount of time.

The base body comprising the PTC-ceramic material has a self regulative property. If the temperature of the base body reaches a critical level, the resistance of the PTC ceramic also rises and thus reduces the electric current running through it. As a result, the PTC ceramic of the base body ceases to heat and is allowed to cool. Thus, no external regulation system is necessary.

According to one embodiment of the nozzle, its base body contains less that 10 parts per million (ppm) of metallic impurities. Metallic impurities are metallic materials that conflict with the desired heating properties of the PTC ceramic. Said desired properties include the ability to vaporize the fluid in the shortest amount of time possible.

It was found that one way to maintain the upper limit of 10 ppm of metallic impurities in a base body of the nozzle is to provide tools used for preparing the ceramic material of the nozzle's base body, such as a ceramic feedstock, with a hard coating preventing the abrasion of the tool into the ceramic material. A suitable coating was determined to include Tungsten Carbide (WC). The base body, itself molded out of the feedstock, thus contains less than 10 ppm of a metallic material contained on any surface of a tool contactable with the ceramic material.

Examples of tools used during the processing of the feedstock are mixing mechanisms, such as a twin-roll mill. This may include two counter-rotating differential speed rollers with an adjustable nip that impose shear stresses on the material of the feedstock as it passes through the nip. Other tools include a single-screw or a twin-screw extruder as well as a ball mill or a blade-type mixer.

One embodiment of the nozzle comprises a base body with a ceramic material with a PTC ceramic having a Curie-temperature between −30° C. and 340° C. In particular, a base body with a PTC ceramic having a resistivity at a temperature of 25° C. in the range of 3 Ωcm to 30000 Ωcm may be used.

A base body comprising a PTC ceramic with the aforementioned properties relating to resistivity and Curie-temperature is suited to vaporizing a fluid flowing through its fluid channel as rapidly as possible.

The base body of the nozzle may contain Barium Titanate (BaTiO₃), a Perowskite ceramic (ABO₃). In particular, according to one embodiment, the base body comprises the structure

Ba_{1-x-y}MₓD_{y}Ti_{1-a-b}NMn_{b}O₃

where x stands for a range between 0 and 0.5 and y, a and b each stand for a range between 0 and 0.01. In this structure M stands for a cation of the valency two, such as for example Ca, Sr or Pb, D stands for a donor of the valency three or four, for example Y, La or rare earth elements, and N stands for a cation of the valency five or six, for example Nb or Sb.

According to one embodiment, the base body may be injection molded from a PTC-ceramic with the following composition:

ABO₃+SiO₂

whereby A is one or more elements chosen from Ba, Ca, Sr, Y and B is one or more element chosen from Ti, Mn and the part of Si is 0.5 to 4.5 mol, e.g., 0.5 to 2.0 mol percent relating to the sum of both components.

The fluid outlet of the nozzle may be connected to a first section of the fluid channel and the fluid inlet to a second section of the fluid channel. The first section comprises a larger diameter than the second. At a given pressure at the fluid inlet, the flow rate of a fluid in the second section of the nozzle is higher than in the first section. The cross section of fluid channel can increase in steps or continually increase in the direction from the fluid inlet to the fluid outlet. Thus, the fluid channel may have a stepped or continuous conical shape.

The fluid outlet may be shaped as a funnel, enabling a particularly homogeneous ejection of the vaporized fluid as a conical spray.

A method for preparing a feedstock injection moldable into a nozzle is also proposed. The method comprises the preparation of a ceramic filler convertible by sintering to a PTC-ceramic. The ceramic filler is mixed with a matrix for binding the filler and the mixture comprising filler and matrix is processed into a granulate. During the preparation of the feedstock, tools contactable with the feedstock are used which have a low degree of abrasion such that a feedstock comprising less than 10 ppm of impurities caused by abrasion is obtained. As previously mentioned, the tools may be provided with a hard coating that prevents said abrasion. The material of the PTC ceramic of the base body may correspond to that of the ceramic filler of the feedstock.

As a result of the at least nearly absent impurities, when the feedstock is injection molded into its desired nozzle shape, its electrical properties such as low resistivity and/or slope of its resistance-temperature curve are maintained in the injection molded nozzle.

Additionally, an injector is proposed comprising an injection molded nozzle according to the embodiments described in this document, wherein a valve is provided preceding the fluid inlet of the nozzle such that it may control the passage of a fluid into the fluid channel of the nozzle.

According to an embodiment of the injector, a preheating element is provided preceding the valve, wherein the preheating element comprises a mold comprising a fluid channel, a fluid inlet and a fluid outlet. The mold further comprises a ceramic material with a positive temperature coefficient, whereby upon application of a current, the mold is heated such that a fluid passing through the fluid channel is preheatable.

The preheated fluid can then be passed via the valve to the injection molded nozzle, where it is rapidly vaporized and ejected via the fluid outlet of the nozzle.

### BRIEF DESCRIPTION OF THE DRAWINGS

The described embodiments are elaborated upon with the help of the following figures and examples.

FIG. 1 is a schematic illustration of an injection molded nozzle,

FIG. 2 is a perspective view of an injection molded nozzle with which a portion of its outer surface and outer electrode strips are shown.

FIG. 3 is a perspective view of an injection molded nozzle depicting an inner part and a passivation layer of the nozzle.

FIG. 4 is a perspective view of an injection molded nozzle depicting laminar protrusions on the inner side of the nozzle's base body.

FIG. 5 is a cross sectional view of an injector comprising the injection molded nozzle.

### DETAILED DESCRIPTION

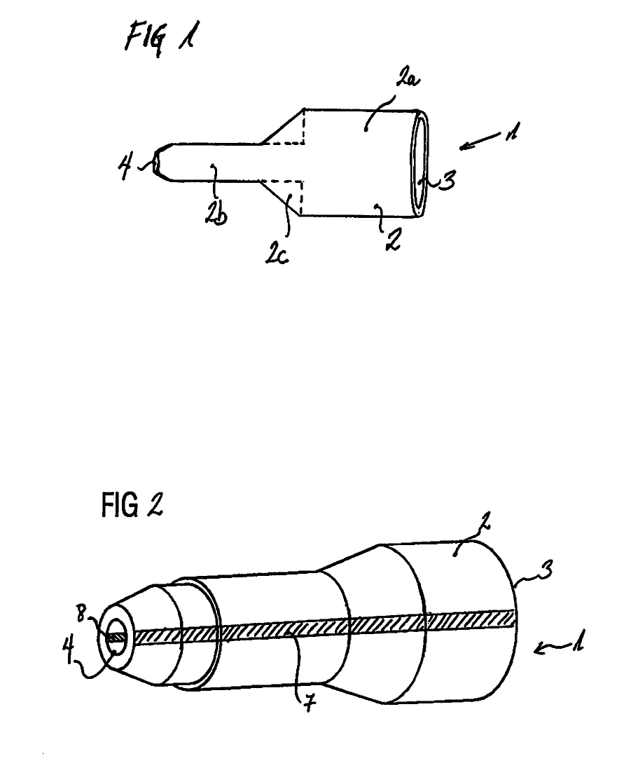

FIG. 1 shows an injection molded nozzle with a base body shaped as a stepped cone comprising a PTC ceramic. The conically shaped base body 2 comprises at least two sections 2a and 2b of differing cross section. The wider of the two sections 2a is connected to a fluid inlet 3 and the narrower of the two sections 2b to a fluid outlet 4. The two sections may be joined together by a sloped third section 2c of varying cross section. However, the two sections 2a and 2b can be joined together directly, whereby the transitional section 2c connecting the two section 2a and 2b with varying cross section is not necessary. The latter scenario is depicted by the dotted line in the figure.

The base body may contain Barium Titanate, in particular of a structure Ba_{1-x-y}MₓD_{y}Ti_{1-a-b}NMn_{b}O₃ as previously described. The base body may comprise a PTC ceramic having a Curie-temperature between −30° C. and 340° C. In particular, the base body may be adjusted to comprise a PTC ceramic having a resistivity at room temperature, in particular at 25° C., in the range of 3 Ωcm to 30000 Ωcm.

More specifically, the PTC ceramic may comprise BaCO₃, TiO₂, Mn-containing solutions and Y-ion containing solutions, for example MnSO₄ and YO_{3/2}, and at least one out of the group of SiO₂, CaCO₃, SrCO₃, and Pb₃O₄. For example, out of these base materials, a ceramic material of a composition

(Ba_{0.3290}Ca_{0.0505}Sr_{0.0969}Pb_{0.1306}Y_{0.005})(Ti_{0.502}Mn_{0.0007})O_{1.5045}

can be provided. A base body of this ceramic material has a characteristic reference temperature Tb of 122° C. and depending on the conditions during sintering, a resistivity range from 40 to 200 Ωcm.

The material and electrical features of the base body described above are valid also for the embodiments described with the help of the following figures.

Subject to a voltage, the base body 2 is heated up such that a fluid flowing through it is correspondingly heated and vaporized. A suitable voltage is 13.5 V (12 V) or 24 V or a voltage in a range between the two, depending on the application of the nozzle. The corresponding current is given by the voltage and the resistance in dependence of the RT characteristic curve of the base body 2.

FIG. 2 shows an injection molded nozzle 1 with a base body 2 in an essentially conical shape, the base body comprising a PTC ceramic. The wider end of the base body 2 is provided with a fluid inlet 3 and the narrower end of the base body with a fluid outlet 4. The fluid outlet 4 is funnel shaped with its wider opening showing out of the base body and its narrower opening pointing into the base body. The fluid outlet and the fluid inlet are connected to each other by a fluid channel 5.

According to an embodiment of the nozzle, the base body is provided with electrodes 7 and 8 of mutually opposite polarity, each of which may have the shape of a strip extending longitudinally along the outer surface of the base body. The electrodes are arranged with a sufficient distance from each other to prevent electrical arcing. Alternatively, one electrode 8 of first polarity may be arranged on the inside surface of the base body, that is, along the fluid channel, and another electrode 7 of opposite polarity on the outside surface of the base body.

The electrodes may comprise at least one material chosen out of the group: Cr, Ni, Al, Ag. The electrodes can be thin film or thick film printed on the respective surfaces of the base body. They may alternatively be applied to the respective surfaces of the base body via galvanic deposition.

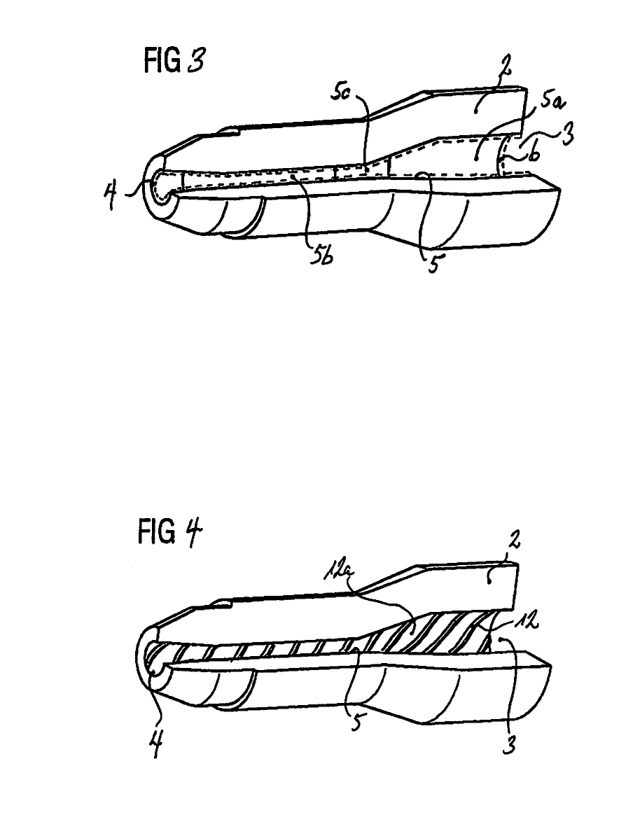

FIG. 3 shows the injection molded nozzle 1 according to FIG. 1, whereby it is shown how the fluid channel 5 comprises a first section 5a connected to the fluid inlet 3 and a second section 5b connected to the fluid outlet 4. At least at one point along the longitudinal axis of the nozzle the first section 5a has a wider diameter or cross section that at a point along the second section 5b of the fluid channel 5. The first and second sections of the fluid channel 5 may comprise constant or nearly constant cross sections.

The first and second sections 5a and 5b of the fluid channel can be connected to each other by a third section 5c. The third section has a narrowing diameter or cross section beginning at the first section 5a and ending at the second section 5b.

Notwithstanding the previously described geometries and shapes, the fluid channel may comprise a continuously decreasing cross section beginning at the fluid inlet 3 and ending at the beginning of the, e.g., funnel shaped fluid outlet 4.

According to one embodiment of the nozzle, the base body is provided with a passivation material comprising an insulative property by which a chemical reaction between the base body and a fluid receivable in the fluid channel, in particular a fuel, is preventable. The passivation material may be applied to the wall of the fluid channel as a layer 6, whose outer surface is shown in FIG. 3 via the dashed line. The passivation layer 6 contains a material particularly preventing a chemical reaction between ethanol, gasoline or diesel with the base body. To this end, glass was found to be a suitable passivation material contained in the passivation layer 6. In particular, it was found that a low melting glass or nano-composite lacquer is suitable. For example, the nano-composite lacquer can comprise one or more of the following composites: SiO₂-polyacrylate-composite, SiO₂-polyether-composite, SiO₂-silicone-composite.

The feature of the passivation layer 6 may be combined with that of the strip shaped electrodes 7 and 8 according to the previous figure. The electrodes 7 and 8 can be burned into the base body already provided with the passivation layer 6, whereby the passivation layer melts away in the area where the electrode 8 on the inner surface of the base body is applied.

According to one embodiment of the nozzle, along the inner surface of the base body 2 being the wall of the fluid channel 5 and/or of the fluid inlet 3 and/or of the fluid outlet 4, at least one protrusion is provided. The protrusion serves to increase the surface area of the channel's wall such that an increased heat exchange surface for vaporizing a fluid contained in the fluid channel is proffered.

According to one embodiment of the protrusion, it may be of laminar shape. A laminar shape is considered to be laminar to the extent that a fluid flowing by it does so in a largely laminar fashion. That is, the protrusion is shaped so as to minimise undue turbulence of the fluid.

According to one embodiment of the protrusion, it is shaped to give the vaporized fluid exiting from the nozzle a particular velocity differing in direction from the longitudinal axis of the nozzle and the direction given by the shape of the fluid outlet. Such a property may comprise a spin of the exiting vaporized fluid or a certain or an off-longitudinal axis spraying direction of the fluid. Thus, the spray exiting the nozzle may comprise a conical shape corresponding to the shape of the fluid outlet, wherein the conical shape may additionally not be rotationally invariant. The spray as a whole may be directed off of the longitudinal axis of the nozzle, thereby being injected into or onto another medium asymmetrically.

The protrusions described in this document may be provided in all sections of the inner surface of the nozzle, thereby including the fluid inlet and the fluid outlet. The protrusions may however be provided along the walls of the fluid channel and the fluid outlet only.

FIG. 4 shows an embodiment according to which along the inner surface of the base body 2, along the fluid channel 5, a plurality of protrusions arranged parallel to each other are provided as twisted ribs. Complementing the ribs, a series of grooves 12a may be provided running parallel to them. The grooves may be seen as sections of the fluid channel's wall devoid of ribs or the grooves may actually be dug into the wall of the fluid channel in the sense that the wall thickness of the base body is thinner in such sections that its average thickness along the longitudinal axis of the body. Such shapes are achievable by injection molding.

A series of ribs or grooves running parallel to each other increases the contact and heat exchange surface of the base body contactable with the fluid. In particular, the ribs or grooves may be arranged helically, that is, they may each run along the wall of fluid channel in a twisted shape. At the same time that such ribs and/or grooves enable the fluid to be vaporized more quickly, twisted ribs can impart a spin to the flowing fluid, such that when the vaporized fluid is ejected from the fluid outlet 3, the ejected spray will spin. A spinning spray of vaporized fluid will be ejected onto another medium, such as the interior of an internal combustion chamber, with a high degree of homogeneity. The spinning spray lends itself to more rapidly attaining a particularly homogenous fuel/air mixture in the combustion chamber.

A combination of the embodiments as specifically depicted by the FIGS. 2 to 4 is possible. In this case, the injection molded nozzle 1 will comprise the base body 2 with electrodes 7 and 8, a passivation layer 6 along the wall of the fluid channel and along the inner all of fluid inlet 3 and the fluid outlet 4 and at least one protrusion 12 along the wall of the fluid channel.

The maximum cross section of the base body may be in the range of 1.8 to 2.2 mm.

The maximum cross section of the fluid inlet 3 may be in the range of 0.8 to 1.2 mm.

The maximum cross section of the fluid inlet 3 may be in the range of 0.8 to 1.2 mm.

The maximum cross section of the fluid channel between the fluid inlet 3 and the fluid outlet 4 may be in a range between 0.1 and 0.5 mm.

The length of the nozzle from the fluid inlet 3 to the fluid outlet 4 via the fluid channel 5 may range between 1 to 2 cm.

The electrodes 7 and 8, when formed as strips, may have maximum widths between 1.8 and 2.2 mm.

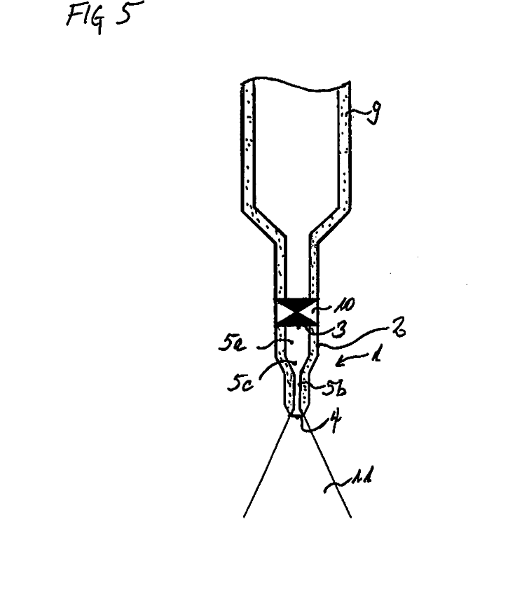

FIG. 5 shows a cross section of an injector comprising an injection molded nozzle 1 according to the described embodiments and an injection molded preheating element 9. The preheating element 9 can be made of the same material in the same manner with the same geometric and/or topographic properties as any embodiment of the base body 2 of the nozzle 1. The preheating element however may not comprise a funnel shaped fluid outlet but instead may comprise a fluid outlet as a continuation of a fluid channel. By preheating a relatively cold fuel before it reaches the nozzle, a more efficiently combustible spray 11 ejected from the outlet 4 of the nozzle is obtained. The PTC-ceramic of the preheater 9 and the current applied are chosen such that the fuel is heated, but preferably not vaporized, before it enters the nozzle via the latter's fluid inlet 3.

Arranged between the injection molded preheater 9 and the injection molded nozzle 1 is a valve 10. The valve may open in dependence of the temperature, and thus pressure, reached in the preheating element 9. The pretension of the valve may be adjusted on experimental basis depending on when the valve is shown to open at a given pressure level in the fluid channel of the preheating element 9. The activation pressure for opening the valve 10 may be at a level sufficient to discharge the fuel into the nozzle. The valve can comprise elastic, such as a spring, that allow it to snap open when the activation pressure is reached. The activation pressure for opening the valve and the corresponding valve pretension are adjusted to allow a flow rate through the nozzle at which the fuel still has time to be vaporized in the nozzle and ejected therefrom as a spray 11.

Other implementations are within the scope of the following claims. Elements of different implementations, including elements from applications incorporated herein by reference, may be combined to form implementations not specifically described herein.

What is claimed is:

1. An injection molded nozzle, comprising:
a base body comprising a fluid channel, a fluid inlet, and a fluid outlet;
wherein base body comprises a ceramic material with a positive temperature coefficient (PTC);
wherein the base body, in response to an electrical current, is configured to vaporize a fluid receivable in the fluid channel by heating; and
wherein the fluid outlet is configured to eject vaporized fluid as a spray.

2. The nozzle according to claim 1, wherein the base body comprises less that 10 ppm of metallic impurities.

3. The nozzle according to claim 1, wherein a ceramic of the base body has a Curie-temperature between −30° C. and 340° C.

4. The nozzle according to claim 1, wherein the base body has a resistivity at a temperature of 25° C. in the range of 3 Ωcm to 30000 Ωcm.

5. The nozzle according to claim 1, wherein the base body comprises Ba_{1-x-y}MₓD_{y}Ti_{1-a-b}NMn_{b}O₃ where x corresponds to a range between 0 and 0.5; and
wherein y, a and b each correspond to a range between 0 and 0.01.

6. The nozzle according to claim 5, wherein the ceramic material comprises: BaCO₃, TiO₂, Mn-containing solutions, and Y-ion containing solutions, and at least one of SiO₂, CaCO₃, SrCO₃, and Pb₃O₄.

7. The nozzle according to claim 6, wherein the Y-ion containing solution comprises MnSO₄ and YO_{3/2}.

8. The nozzle according to claim 1, wherein the fluid outlet is connected to a first section of the fluid channel and the fluid inlet is connected to a second section of the fluid channel, the first section comprising a larger diameter than the second section.

9. The nozzle according to claim 1, wherein a cross section of fluid channel increases in a direction from the fluid inlet to the fluid outlet.

10. The nozzle according to claim 1, wherein the fluid outlet is funnel shaped.

11. The nozzle according to claim 1, wherein the base body comprises a passivation material having a property to hinder a chemical reaction between the base body and a fluid receivable in the fluid channel.

12. The nozzle according to claim 1, wherein electrical properties of the ceramic material are adjusted to vaporize a chemical combustion fuel.

13. The nozzle according to claim 12, wherein the chemical combustion fuel comprises one of ethanol, gasoline and diesel.

14. The nozzle according to claim 13, wherein the passivation layer contains glass.

15. The nozzle according to claim 11, wherein the passivation material contains a nano-composite lacquer.

16. The nozzle according to claim 15, wherein the nano-composite lacquer comprises at least one of: SiO₂-polyacrylate-composite, SiO₂-polyether-composite, SiO₂-silicone-composite.

17. The nozzle according to claim 1, wherein the base body comprises oppositely-poled electrode layers, each oppositely-poled electrode layer comprising a shape of a strip extending longitudinally along an outer surface of the base body.

18. The nozzle according to claim 17, wherein the oppositely-poled electrode layers comprise at least one of the following materials: Cr, Ni, Al, Ag.

19. The nozzle according to claim 17, wherein a first electrode is on an inner surface of the base body and a second electrode is on the outer surface of the base body.

20. The nozzle according to claim 17, wherein the oppositely-poled electrode layers are on the outer surface of the base body and are separated by a space.

21. An injector comprising:
a nozzle according to claim 1; and
a valve preceding the fluid inlet of the nozzle such that entry of a fluid into the fluid channel of the nozzle is controllable by the valve.

22. The injector according to claim 21, further comprising:
a preheating element preceding the valve, the preheating element comprising a mold with a fluid channel, a fluid inlet and a fluid outlet, the mold comprising a ceramic material with a positive temperature coefficient, wherein, upon application of a current, the mold is heated such that a fluid passing through the fluid channel is preheated prior to entering the nozzle.

23. The injector according to claim 21, wherein the valve is pretensioned to open when pressure inside the preheating element reaches a predefined level.
